(19) United States
(12) Patent Application Publication
(10) Pub. No.: US 2017/0123458 A1
(43) Pub. Date: May 4, 2017

(54) Electronic Device Case with Animated Display

(71) Applicant: Willie L. Perry, Columbus, GA (US)

(72) Inventor: Willie L. Perry, Columbus, GA (US)

(21) Appl. No.: 15/060,309

(22) Filed: Mar. 3, 2016

Related U.S. Application Data
(60) Provisional application No. 62/250,057, filed on Nov. 3, 2015.

(51) Int. Cl. G06F 1/16; H04M 1/02; H04B 1/3888

(52) U.S. Cl. CPC G06F 1/1647; H04B 1/3888; G06F 1/1654; H04M 1/0202

(57) ABSTRACT

An electronic device case with animated display is a case that is designed to provide physical protection to an electronic device as well as display a still image or video on a display on the case. An electronic device may be seated into a device-receiving slot located on a casing. A digital display is positioned on the casing and is capable of displaying a still image or video as configured by the user. The media content that is shown on the digital display is regulated by a control unit and electronic components of the case are supplied electrical power from a power supply. The power supply may additionally provide electrical power to the electronic device through a device connector positioned within the device-receiving slot. Media content may be stored on a storage device enclosed within the casing.

The current application claims a priority to the U.S. Provisional Patent application Ser. No. 62/250,057 filed on Nov. 3, 2015.

### FIELD OF THE INVENTION

The present invention relates generally to cases for electronic devices such as smartphones and tablet computers. More specifically, the present invention is an electronic device case with animated display.

### BACKGROUND OF THE INVENTION

When purchasing a costly electronic device such as a smartphone or a tablet computer, it is common to purchase an accompanying case in order to protect the electronic device. In addition to protection, a case may be utilized for decorative purposes as well as to express the owner's personality. Cases are available in a wide variety ranging from minimalistic cases that display the design of electronic devices to more functional cases that serve dual purposes such as wallets and personal mirrors. Some types of cases may additionally serve as kickstands in order to enhance the experience of viewing media such as a video on an electronic device.

The present invention is an electronic device case with animated display that allows a still image or a video to be played on a display located on the case. The present invention additionally provides physical protection for an electronic device that is contained within the present invention. The user is able to configure the present invention in order to customize the media content that is played on the display. The present invention is designed in a manner such that normal use of the electronic device within the present invention is not hindered. The present invention includes an integrated power source that provides electrical power to the electronic components of the present invention.

### BRIEF DESCRIPTION OF THE DRAWINGS

FIG. 1 is a front perspective view of the present invention.

FIG. 2 is a rear perspective view of the present invention.

FIG. 3 is a diagram of electronic and electrical connections of the present invention.

FIG. 4 is a diagram of additional electronic and electrical connections of the present invention.

FIG. 5 is a diagram of additional electronic and electrical connections of the present invention.

FIG. 6 is a diagram of additional electronic and electrical connections of the present invention.

FIG. 7 is a diagram of additional electronic and electrical connections of the present invention.

FIG. 8 is a diagram of additional electronic and electrical connections of the present invention.

FIG. 9 is a diagram of additional electronic and electrical connections of the present invention.

FIG. 10 is an exploded front perspective view of the present invention with an electronic device.

FIG. 11 is a front perspective view of the present invention with an electronic device.

### DETAIL DESCRIPTIONS OF THE INVENTION

All illustrations of the drawings are for the purpose of describing selected versions of the present invention and are not intended to limit the scope of the present invention.

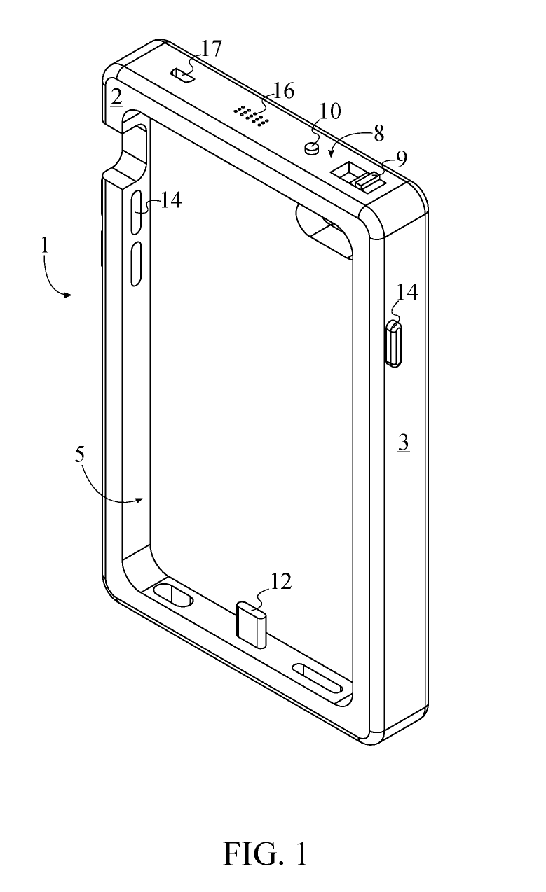

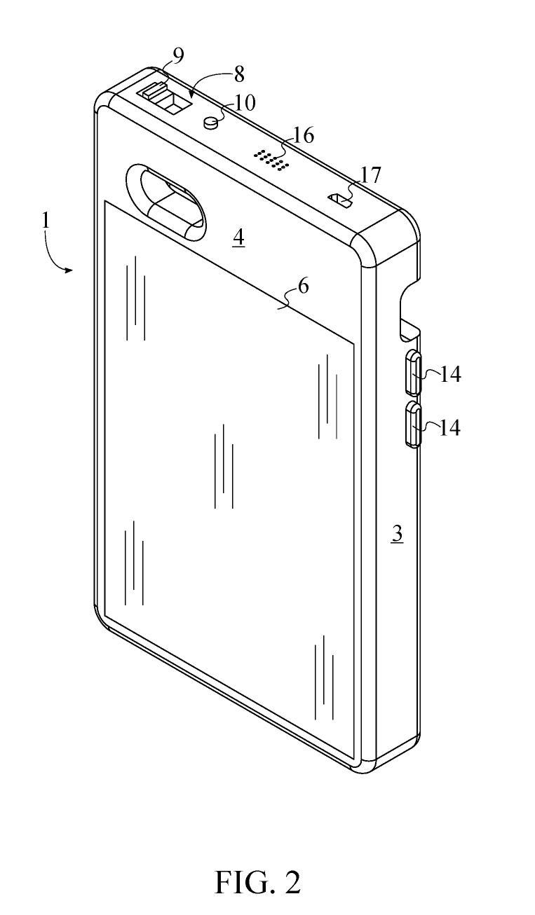

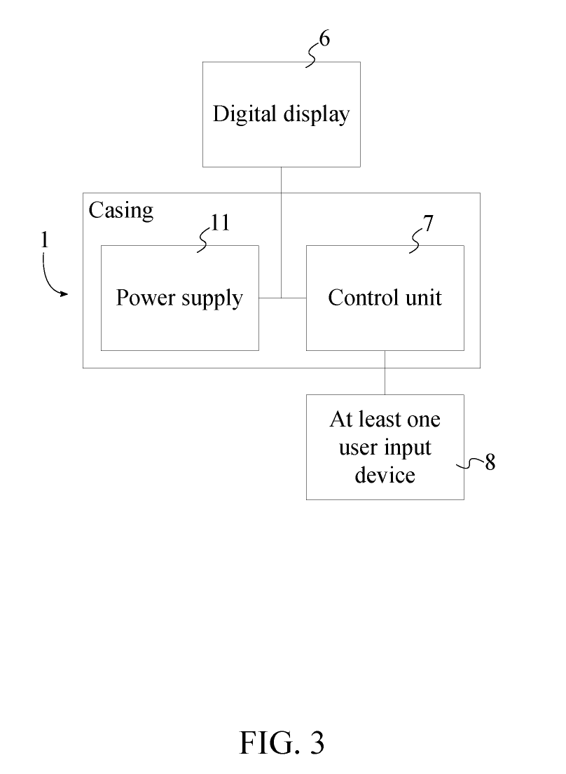

The present invention is an electronic device case with animated display. The present invention is shown in FIG. 1 and FIG. 2 while electronic connections of the present invention are shown in FIGS. 3-9. The present invention comprises a casing 1, a device-receiving slot 5, a digital display 6, a control unit 7, at least one user input device 8, and a power supply 11.

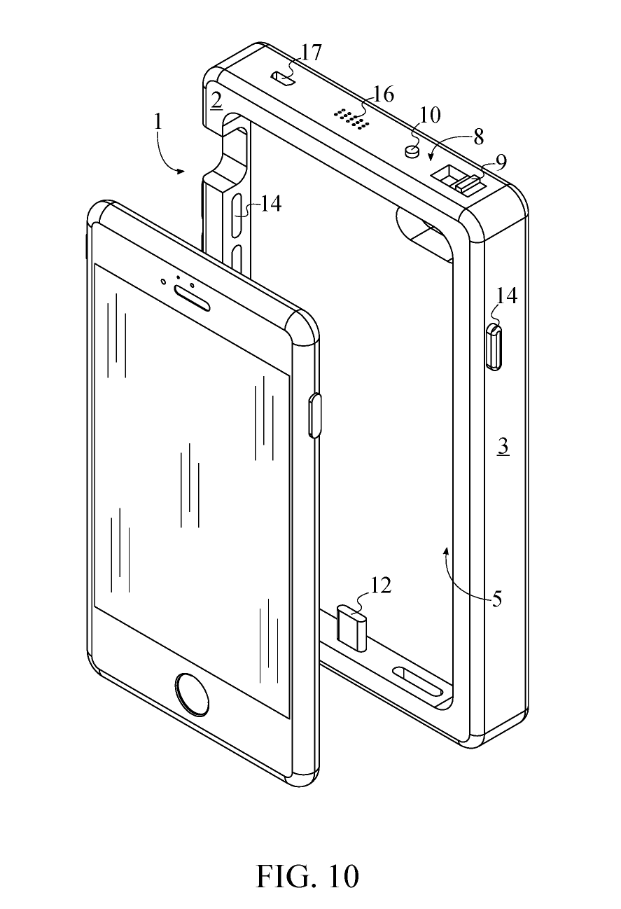

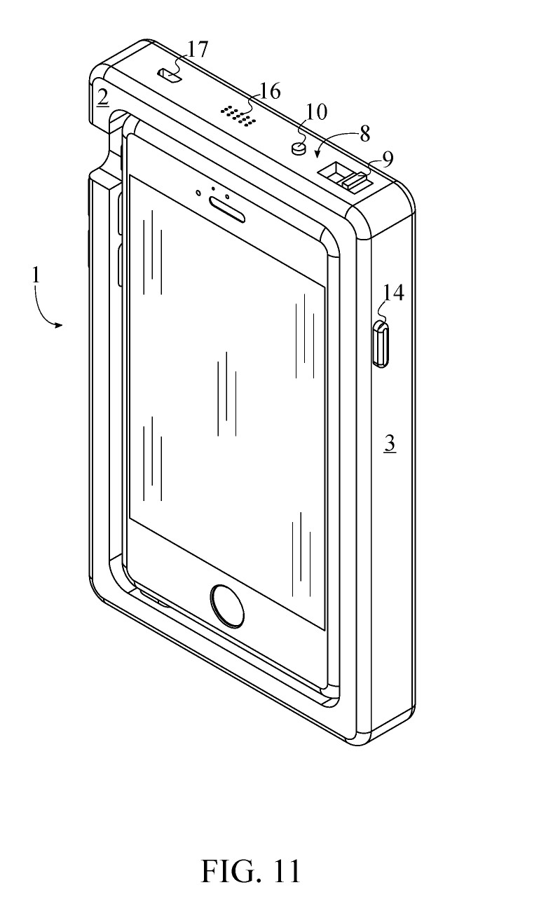

With further reference to FIGS. 1-9, the casing 1 provides physical protection to an electronic device such as, but not limited to, a smartphone or tablet computer. The casing 1 is preferably composed of a protective material such as silicone or thermoplastic polyurethane (TPU). The casing 1 comprises a front surface 2, a lateral surface 3, and a rear surface 4. The front surface 2 and the rear surface 4 are opposing surfaces of the casing 1 while the lateral surface 3 is positioned in between the front surface 2 and the rear surface 4. The device-receiving slot 5 is the opening into which the electronic device may be seated for protection within the casing 1. The device-receiving slot 5 traverses into the front surface 2, allowing the electronic device to be seated into the casing 1 as shown in FIG. 10 and FIG. 11. In the preferred embodiment of the present invention, the device-receiving slot 5 is positioned in a manner such that the display of the electronic device is oriented toward the front surface 2.

Again with reference to FIGS. 1-9, the digital display 6 is an electronic display that is capable of displaying a still image or a moving image such as a video. The digital display 6 is positioned on the rear surface 4 and is thus oriented away from the device-receiving slot 5. The image or video that is displayed on the digital display 6 is determined by the control unit 7. The control unit 7 includes a processor or similar electronic device that regulates the media content that is displayed on the digital display 6. As such, the digital display 6 is electronically connected to the control unit 7 as shown in FIG. 3. The digital display 6 may be flexible as in the case of a flexible organic light-emitting diode (FOLED) display. This greatly facilitates the insertion into and removal from the device-receiving slot 5 of the electronic device when the casing 1 is composed of a similarly flexible material.

With continued reference to FIGS. 1-9, the at least one user input device 8 is a button, switch, or similar device that allows the user to perform various actions such as turning the digital display 6 on or off. The at least one user input device 8 is externally positioned on the casing 1 for convenient access. As shown in FIG. 3, the at least one user input device 8 is electronically connected to the control unit 7, allowing the control unit 7 to process commands that are provided through the at least one user input device 8.

The power supply 11 provides electrical power to the electronic components of the present invention. The power supply 11 is enclosed within the casing 1 for protection and is preferably contained within a dedicated slot such as a battery compartment. The power supply 11 may be replaceable or rechargeable. The power supply 11 is electrically connected to the digital display 6 and the control unit 7 as shown in FIG. 3, enabling the power supply 11 to provide electrical power to the digital display 6 and the control unit 7.

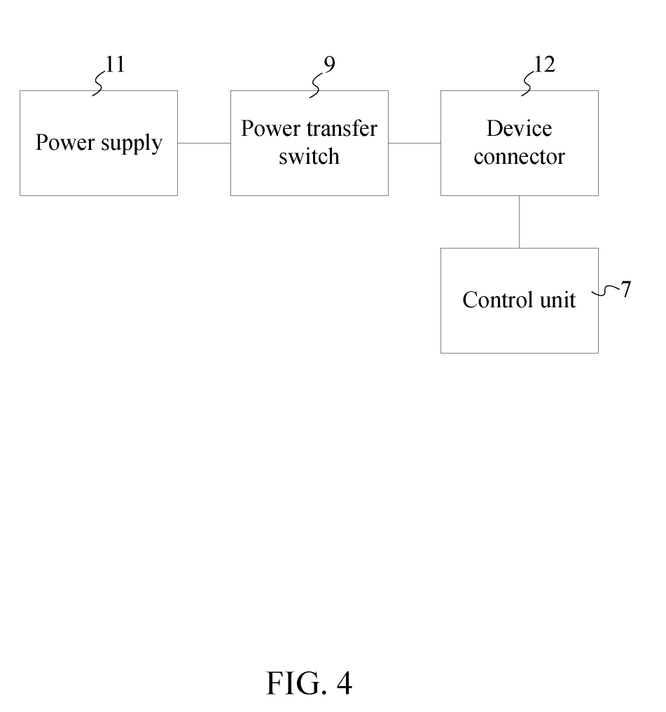

The power supply 11 may additionally provide electrical power to and charge the electronic device. The present invention further comprises a device connector 12 that is utilized to electronically connect the electronic device to the present invention. The at least one user input device 8 comprises a power transfer switch 9 that allows the user to enable or disable electrical power transfer to the electronic device. As shown in FIG. 4, the power supply 11 is electrically connected to the device connector 12 through the power transfer switch 9. As such, the power transfer switch 9 may be utilized to enable or disable electrical power transfer from the power supply 11 to the device connector 12. The power transfer switch 9 is externally positioned on the casing 1 for convenient access as shown in FIG. 1 and FIG. 2. The device connector 12 is positioned within the device-receiving slot 5, enabling the electronic device to be electronically connected to the device connector 12 when seated into the device-receiving slot 5. The device connector 12 is electronically connected to the control unit 7 as shown in FIG. 4, allowing the control unit 7 to detect the electronic device when the electronic device is connected to the device connector 12.

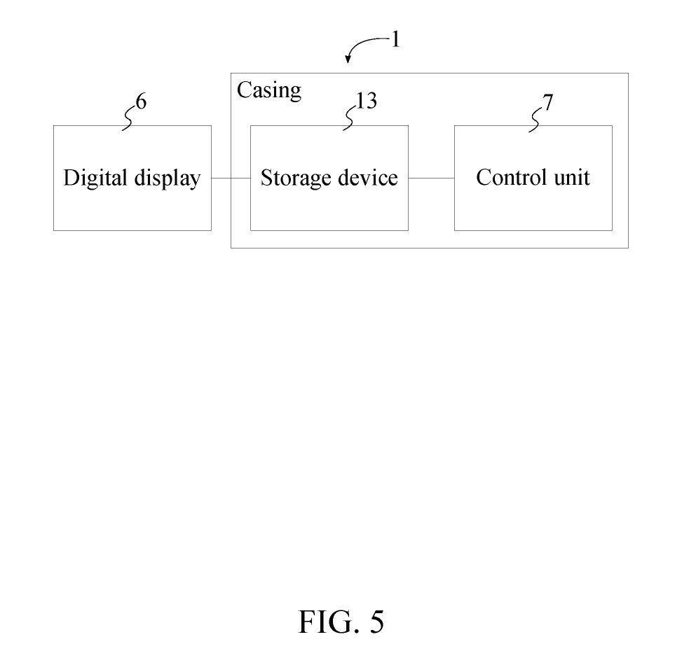

With further reference to FIGS. 1-9, the media content that is displayed on the digital display 6 may be drawn directly from the electronic device or alternatively, from the present invention itself. As such, the present invention further comprises a storage device 13 on which media content may be stored. In the preferred embodiment of the present invention, the storage device 13 is a hard drive or similar device that is capable of storing media content. The storage device 13 is enclosed within the casing 1 for protection. Additionally, as shown in FIG. 5, the storage device 13 is electronically connected to the digital display 6 and the control unit 7. The control unit 7 is thus able to regulate the media content that is drawn from the storage device 13 and displayed on the digital display 6.

As shown in FIG. 1 and FIG. 2, the present invention further comprises at least one device input actuator 14 that enables the user to utilize various input devices on the electronic device such as volume adjustment buttons. Because the input devices of electronic devices are often positioned on the sides of the electronic devices, in the preferred embodiment of the present invention, the at least one device input actuator 14 is engaged through the lateral surface 3. This enables the at least one device input actuator 14 to be pressed through the lateral surface 3 when the electronic device is seated into the device-receiving slot 5, allowing the at least one device input actuator 14 to press the input devices of the electronic device.

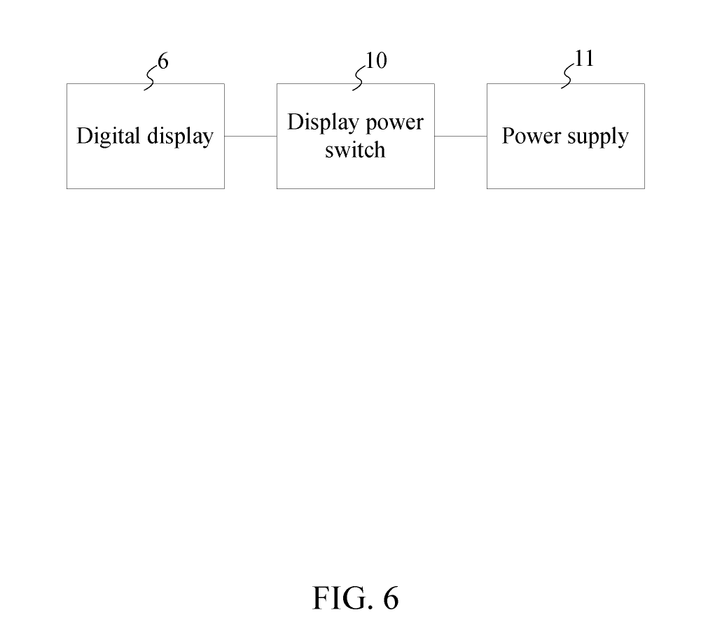

The at least one user input device 8 further comprises a display power switch 10. The display power switch 10 is utilized to turn the digital display 6 on or off as needed. The digital display 6 is electrically connected to the power supply 11 through the display power switch 10 as shown in FIG. 6. As such, the display power switch 10 may be utilized to enable or disable electrical power transfer from the power supply 11 to the digital display 6. The display power switch 10 is externally positioned on the casing 1 for convenient access.

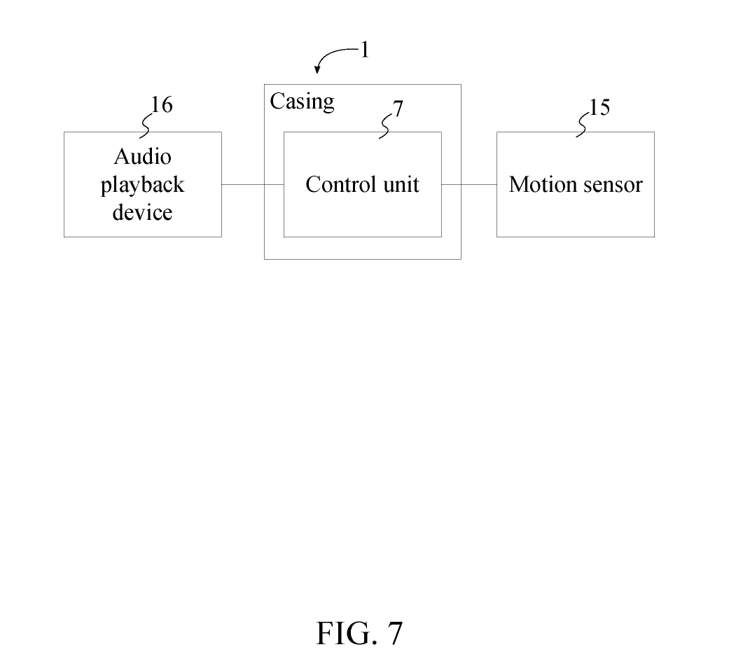

With reference to FIG. 7, in order to prevent waste of electrical power, the present invention may include a means of disabling the digital display 6 as the user desires. One such means is by disabling the digital display 6 when the present invention is not in motion (for example, resting on a surface and not in use). The present invention further comprises a motion sensor 15 that is able to determine if the present invention and by extension, the electronic device, are in active use. The motion sensor 15 is electronically connected to the control unit 7, allowing the control unit 7 to disable the digital display 6 when it is detected by the motion sensor 15 that the present invention is not physically moving and is thus not in use. The settings for the motion sensor 15 may be configured through the control unit 7 as well.

With reference to FIG. 1, FIG. 2, and FIG. 7, in addition to displaying an image or video on the digital display 6, the present invention may output accompanying audio as well. As such, the present invention further comprises an audio playback device 16 such as a speaker. The audio playback device 16 is externally positioned on the casing 1, allowing the audio to be emitted from the casing 1. The audio playback device 16 is electronically connected to the control unit 7, allowing the control unit 7 to regulate the media content that is output from the audio playback device 16.

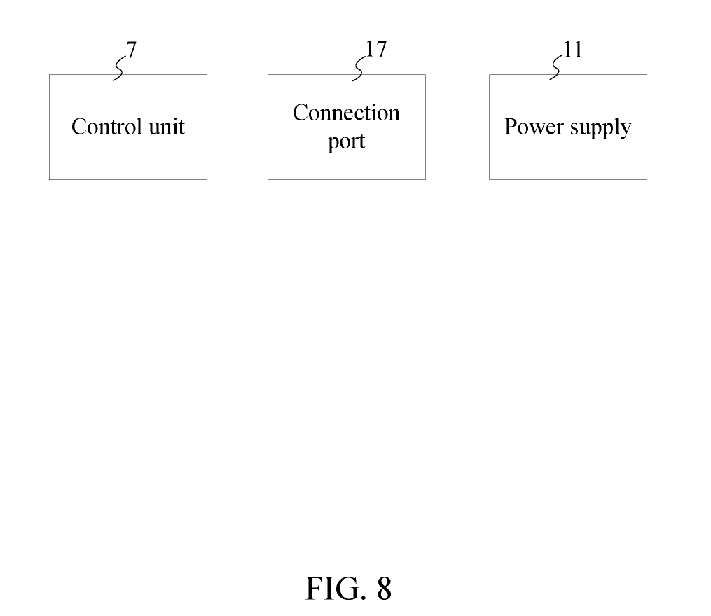

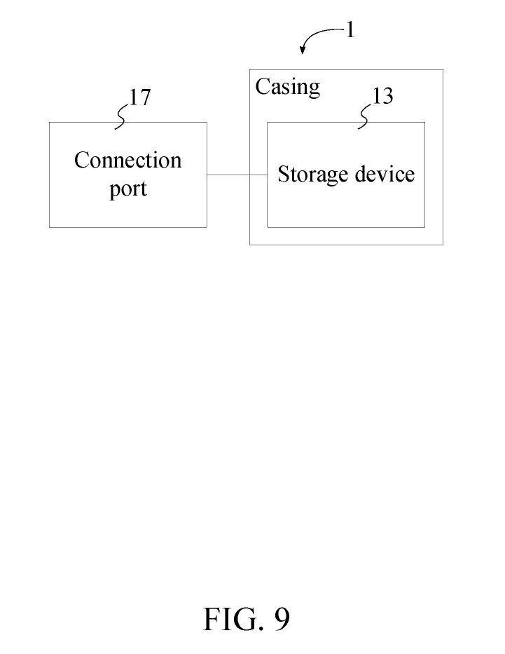

The present invention may be connected to an external electronic device such as a computer (for example, when transferring media content from the external electronic device to the storage device 13 of the present invention). As shown in FIG. 1, FIG. 2, FIG. 8, and FIG. 9, the present invention further comprises a connection port 17 such as, but not limited to, a Universal Serial Bus (USB) port that may be utilized to connect the present invention to the external electronic device. The connection port 17 traverses into the casing 1. This allows a cable or similar device to be inserted into the connection port 17. The connection port 17 is electronically connected to the control unit 7, enabling the control unit 7 to be electronically connected to the external electronic device. Additionally, the connection port 17 is electrically connected to the power supply 11, allowing the power supply 11 to provide electrical power to the connection port 17. Finally, the storage device 13 is electronically connected to the connection port 17, enabling media content from the external electronic device to be transferred to the storage device 13 through the connection port 17. In the preferred embodiment of the present invention, the connection port 17 is positioned on the lateral surface 3, away from the digital display 6 and the device-receiving slot 5.

Although the present invention has been explained in relation to its preferred embodiment, it is understood that many other possible modifications and variations can be made without departing from the spirit and scope of the present invention as hereinafter claimed.

What is claimed is:

1. An electronic device case with animated display comprises:
a casing;
a device-receiving slot;
a digital display;
a control unit;
at least one user input device;
a power supply;
the casing comprises a front surface, a lateral surface, and a rear surface;
the device-receiving slot traversing into the front surface;
the digital display being positioned on the rear surface;
the digital display being electronically connected to the control unit;
the at least one user input device being externally positioned on the casing;
the at least one user input device being electronically connected to the control unit;
the power supply being enclosed within the casing; and
the power supply being electrically connected to the digital display and the control unit.

2. The electronic device case with animated display as claimed in claim 1 further comprises:
a device connector;
the at least one user input device comprises a power transfer switch;
the power supply being electrically connected to the device connector through the power transfer switch;
the device connector being positioned within the device-receiving slot;
the device connector being electronically connected to the control unit; and
the power transfer switch being externally positioned on the casing.

3. The electronic device case with animated display as claimed in claim 1 further comprises:
a storage device;
the storage device being enclosed within the casing; and
the storage device being electronically connected to the digital display and the control unit.

4. The electronic device case with animated display as claimed in claim 1 further comprises:
at least one device input actuator; and
the at least one device input actuator being engaged through the lateral surface.

5. The electronic device case with animated display as claimed in claim 1 further comprises:
the at least one user input device comprises a display power switch;
the digital display being electrically connected to the power supply through the display power switch; and
the display power switch being externally positioned on the casing.

6. The electronic device case with animated display as claimed in claim 1 further comprises:
a motion sensor; and
the motion sensor being electronically connected to the control unit.

7. The electronic device case with animated display as claimed in claim 1 further comprises:
an audio playback device;
the audio playback device being externally positioned on the casing; and
the audio playback device being electronically connected to the control unit.

8. The electronic device case with animated display as claimed in claim 1 further comprises:
a connection port;
the connection port traversing into the casing;
the connection port being electronically connected to the control unit; and
the connection port being electrically connected to the power supply.

9. The electronic device case with animated display as claimed in claim 8 further comprises:
the connection port being positioned on the lateral surface.

10. The electronic device case with animated display as claimed in claim 8 further comprises:
a storage device;
the storage device being enclosed within the casing; and
the storage device being electronically connected to the connection port.

11. An electronic device case with animated display comprises:
a casing;
a device-receiving slot;
a digital display;
a control unit;
at least one user input device;
a power supply;
a motion sensor;
the casing comprises a front surface, a lateral surface, and a rear surface;
the device-receiving slot traversing into the front surface;
the digital display being positioned on the rear surface;
the digital display being electronically connected to the control unit;
the at least one user input device being externally positioned on the casing;
the at least one user input device being electronically connected to the control unit;
the power supply being enclosed within the casing;
the power supply being electrically connected to the digital display and the control unit; and
the motion sensor being electronically connected to the control unit.

12. The electronic device case with animated display as claimed in claim 11 further comprises:
a device connector;
the at least one user input device comprises a power transfer switch;
the power supply being electrically connected to the device connector through the power transfer switch;
the device connector being positioned within the device-receiving slot;
the device connector being electronically connected to the control unit; and
the power transfer switch being externally positioned on the casing.

13. The electronic device case with animated display as claimed in claim 11 further comprises:
a storage device;
the storage device being enclosed within the casing; and
the storage device being electronically connected to the digital display and the control unit.

14. The electronic device case with animated display as claimed in claim 11 further comprises:
at least one device input actuator; and
the at least one device input actuator being engaged through the lateral surface.

15. The electronic device case with animated display as claimed in claim 11 further comprises:
the at least one user input device comprises a display power switch;
the digital display being electrically connected to the power supply through the display power switch; and
the display power switch being externally positioned on the casing.

16. The electronic device case with animated display as claimed in claim 11 further comprises:
an audio playback device;
the audio playback device being externally positioned on the casing; and
the audio playback device being electronically connected to the control unit.

17. The electronic device case with animated display as claimed in claim 11 further comprises:
a connection port;
the connection port traversing into the casing;
the connection port being electronically connected to the control unit; and
the connection port being electrically connected to the power supply.

18. The electronic device case with animated display as claimed in claim 17 further comprises:
the connection port being positioned on the lateral surface.

19. The electronic device case with animated display as claimed in claim 17 further comprises:
a storage device;
the storage device being enclosed within the casing; and
the storage device being electronically connected to the connection port.
